(19) United States
(12) Patent Application Publication
(10) Pub. No.: US 2014/0056314 A1
(43) Pub. Date: Feb. 27, 2014

(54) SYSTEMS AND METHODS FOR PRIORITIZING DATA PACKET DELIVERY

(71) Applicant: Baruch Sterman, Efrat (IL)

(72) Inventor: Baruch Sterman, Efrat (IL)

(21) Appl. No.: 13/591,833

(22) Filed: Aug. 22, 2012

(51) Int. Cl. H04L 12/24

(52) U.S. Cl. 370/465

(57) ABSTRACT

When multiple users of an IP telephony system are communicating with the IP telephony system via the same data network interface device, a check is made to determine if all users are obtaining sufficiently high communications speed to support high quality communications. If not, the data traffic for one or more users may be slowed to allow data traffic to one or more other users to be increased, so that all users will be able to maintain high quality communications.

### BACKGROUND OF THE INVENTION

The invention is related to Internet protocol (IP) telephony systems that allow users to place and receive telephone calls, video calls, to send and receive text and video messages, and to send and receive other forms of telephony and data communications. Such communications are carried, at least in part, via data packets that are communicated over a data network. The data network is commonly the Internet.

Users of an IP telephony system obtain services from the IP telephony system via the Internet or some other data network, and thus the users IP telephony devices must gain access to the data network. Access to a data network is usually obtained via a data network interface device, such as a router, a wireless access point, or possibly a cellular data channel.

Many data network interface devices are designed to permit multiple users, or multiple computing devices, to simultaneously access the data network. The total available bandwidth provided by a data network interface device is split between any users who are actively communicating through the data network interface device. This can cause problems if one or more users need more bandwidth to effectively communicate than is presently available due to the data communications of other users who are also actively communicating through the data network interface device.

Some systems are designed so that if a single user is attempting to conduct multiple forms of communication through a data network interface device, the data packets carrying one form of communication are given priority over the data packets carrying another form of communication. For example, if a user is simultaneously conducting an Internet Protocol (IP) telephone call and attempting to upload or download a video or other type of file, the system may give priority to the data packets carrying the media of the IP telephone call so that call quality remains high. This can involve actively slowing the bit rate of the incoming and outgoing communications which are not carrying the media of the IP telephone call.

While this method of controlling the data traffic can be effective with respect to a single user, if two different users are simultaneously communicating through the same data network interface device, where a first user is conducting an IP telephone call and where a second user is downloading photos, there is no way to prioritize the data traffic of the first user over the second user. What is needed is a system for controlling the data traffic for multiple users who are communicating through the same data network interface device so that any users who need a high bit rate to conduct high quality communications receive that high bit rate.

### BRIEF DESCRIPTION OF THE DRAWINGS

FIG. 1 is a diagram of a communications environment including various elements which are associated with an Internet protocol (IP) telephony system operating in accordance with the invention;

FIG. 2 is a block diagram of various elements of a processor that forms part of an IP telephony system operating in accordance with the invention;

FIG. 3 is a block diagram illustrating elements of a data control unit that acts to prioritize and control the flow of data to and from multiple IP telephony devices that are communicating through the same data network interface device;

FIG. 4 is flowchart illustrating steps of a method of prioritizing and controlling the flow of data to and from multiple IP telephony devices that are communicating through the same data network interface device; and

FIG. 5 is a diagram illustrating steps of method of determining when and how to act to control the flow of data to and from multiple IP telephony devices that are communicating through the same data network interface device.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text and video communications using Internet protocol data communications.

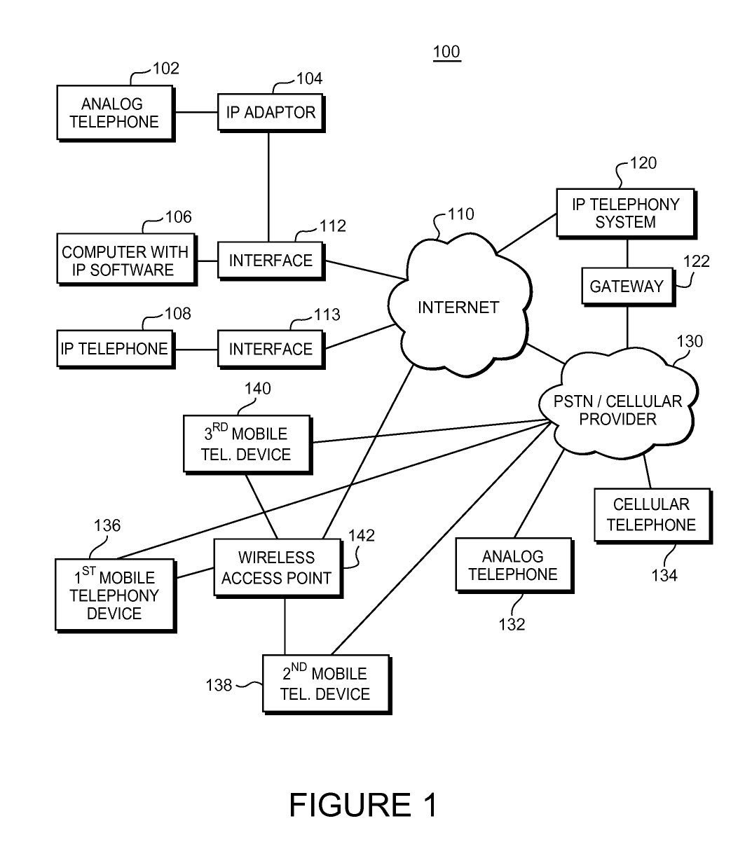

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 by an interface 113. The interface 113 could be any of multiple devices that are used to obtain access to a data network, such as the Internet 110. In some embodiments, the IP telephone 108 could be connected to the interface 113 via a wired connection. In other instances, the IP telephone 108 could be connected to the interface 113 by a separate wireless router (not shown). In yet other instances, the interface 113 could include its own wireless router.

Alternatively, a customer could utilize an analog telephone 102 which is connected to the Internet 110 via an IP adapter 104, which is itself coupled to an interface 112 to the Internet. In some embodiments, the functions of the IP adaptor 104 and the interface 111 could be combined into a single unit. The telephone adapter 104 converts analog signals from the analog telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 to place and receive IP based telephone calls, and to access other IP telephony systems (not shown). The computer 106 is coupled to the Internet via the same interface 112 as the analog telephone 102 and the IP adaptor 104. The computer could have a wired or wireless connection to the interface 112. Also, in some embodiments, a separate wireless router (not shown) could be logically interposed between the computer 106 and the interface 112 to the Internet 110. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to conduct an audio or video telephone call, to send and receive text (SMS/MMS) messages, and to conduct other forms of data communications, such as uploading and downloading files. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the Apple iPhone™, that includes both cellular telephone capabilities and a wireless data transceiver that can establish a wireless data connection to a data network. Such a mobile computing device could run appropriate application software to conduct VOIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

FIG. 1 illustrates that first, second and third mobile telephony devices 136/138/140 are capable of establishing a wireless data connection to the Internet 110 via a wireless access point 142. Assuming the mobile telephony devices 136/138/140 include cellular telephone capabilities, the mobile telephony devices 136/138/140 could also establish a data connection to the Internet 110, and then to the IP telephony system 120, via a data channel provided by a cellular service provider 130.

Although not illustrated in FIG. 1, the mobile telephony devices 136/138/140 may be capable of establishing a wireless data connection to a data network, such as the Internet 110, via alternate means. For example, the mobile computing devices 136/138/140 might link to some other type of wireless interface using an alternate communication protocol, such as the WiMax standard, or some other standard that is later developed. Also, the wireless access point 142 illustrated in FIG. 1 could operate using any standard that allows a data connection to a data network.

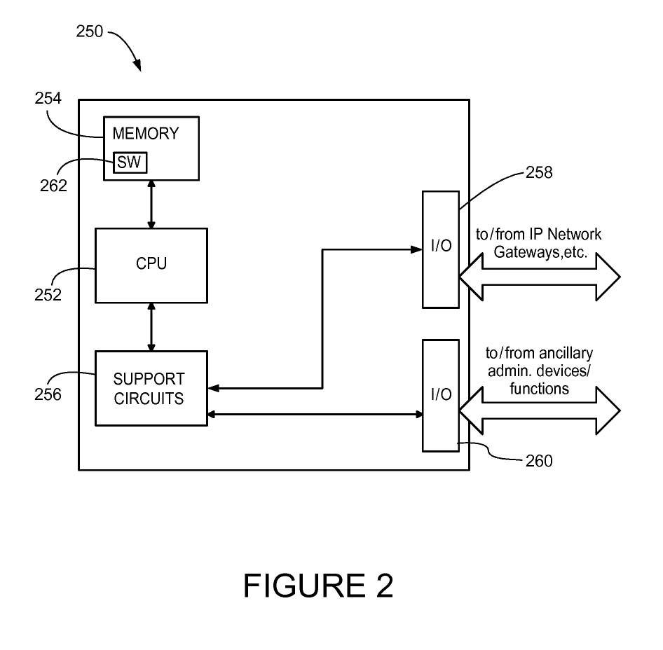

FIG. 2 illustrates elements of a computer processor 250 that can be used as part of the IP telephony system 120 to accomplish various functions. The IP telephony system 120 could include multiple processors 250 located at various locations in the system, along with their operating components and programming, each carrying out a specific or dedicated portion of the functions performed by the VOIP based telephony service 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment via the IP network, gateways or other such connection points, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

The following description will refer to telephony communications. The term telephony communications is intended to encompass any type of communication that could pass back and forth between users of an IP telephony system. This includes audio and video telephone calls, text messages, video messages, the uploading and downloading of data files, and any other form of telephony or data communication.

As mentioned in the Background Section, two different users may communicate with an IP telephony system 120 via the same data network interface device. FIG. 1 illustrates two examples of this. The analog telephone 102 and IP adaptor 104 communicate thorough interface 112, as does the computer with IP software 106. Also, the first, second and third mobile telephony devices 136/138/142 all communicate with the IP telephony system 120 through the wireless access point 142.

If a first user is conducting an IP telephone call via the IP telephony system 120 using the analog telephone 102 at the same time that a second user is downloading files using the computer with IP software 106, both users will be using a portion of the total available bandwidth provided by the interface 112. If the portion of the bandwidth available to the first user is too small, meaning the bit rate of data communications flowing to and away from the IP adaptor 104 is too low, the quality of the IP telephone call will suffer. On the other hand, the second user may not need to download files with great speed. Under these circumstances, it would be advantageous if the bit rate for data communications to the computer with IP software 106 were slowed so that the bit rate for data communications to the IP adaptor 104 could be increased, thereby improving the quality of the IP telephone call being conducted by the first user.

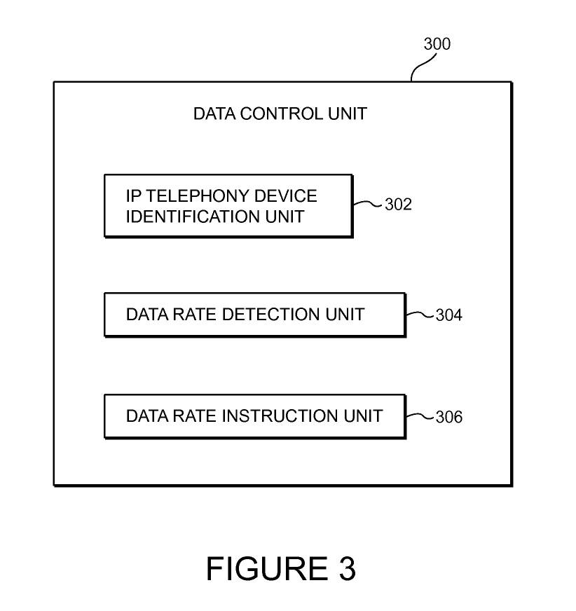

FIG. 3 illustrates elements of a data control unit 300 that would be part of an IP telephony system 120. The data control unit 300 is configured to identify when two or more users are communicating with the IP telephony system 120 simultaneously through the same data network interface device. When this is occurring, the data control unit 300 checks to determine the type of communications being conducted by each of those users. If one or more of the users is conducting a type of communication that requires a certain bit rate to maintain high quality, the data control unit 300 checks to determine if the user is being provided with that bit rate. If not, the data control unit 300 checks to determine if the bit rate of communications for other users who are also communicating via the data network interface device can be slowed without impacting the quality of the communications. If so, the data control unit acts to slow communications for those users who will not be negatively impacted by a reduction in their communication speed, to thereby free up some of the available bandwidth for those users who require higher speed communications.

The data control unit 300 includes an IP telephony device identification unit 302 which is configured to determine when two or more users are communicating with the IP telephony system 120 via the same data network interface device. This can be accomplished by comparing the originating IP addresses of the data packets being received from each of the users who are actively communicating with the IP telephony system 120. If the originating IP addresses of the data packets received from first and second users is the same, this indicates that the first and second users are communicating via the same data network interface device. Likewise, the IP telephony device identification unit 302 may also compare the destination IP addresses of data packets that are being sent from the IP telephony system 120 to the users to determine if there are matches.

It may also be possible to identify when two or more users are communicating through the same network interface device using location data as reported from the users' telephony devices. For example, if two telephony devices report exactly the same location coordinates, as determined by GPS receivers or some other form of location determining devices, then there is a possibility that the two telephony devices are both communicating via the same wireless access point. Thus, location information could be used instead of IP addresses to determine that two or more telephony devices are accessing the data network via the same data network interface device. Alternatively both IP addresses and location information could be used together to arrive at a determination that two or more telephony devices are accessing the data network via the same data network interface device.

The data control unit 300 also includes a data rate detection unit 304. When the IP telephony device identification unit 302 determines that multiple users are communicating with the IP telephony system 120 via the same data network interface device, the data rate detection unit 304 examines the communications being conducted by each of those multiple users. The data rate detection unit 304 determines the types of communications that are being conducted, and the present bit rate of those communications. The type of communication may already be known by the IP telephony system 120, and this the data rate detection unit 304, or the type of communications may be determined by examining the format of the data packets being sent to each of the multiple users.

The data rate detection unit 304 might also examine the pattern of a user's data communications to determine the type of communication being conducted by the user. For example, if the user is conducting an IP based telephone call, the data packet communications will likely follow a first pattern, whereas a user who is downloading a file or surfing the Internet will likely exhibit a different pattern of data packet communications. Thus, the pattern of a user's data packet traffic may also be used to determine the type of communications being conducted.

The data rate detection unit 304 then determines whether the current bit rates for the communications of each of the multiple users is sufficient to support quality communications. If not, the data rate detection unit determines if the data communications of one or more of the multiple users could be slowed without impacting the quality of their communications. If so, the data rate detection unit 304 determines how much to slow the data communications of one or more users so that enough bandwidth can be made available to provide other users with the bit rates required to maintain high quality communications.

The data control unit 300 also includes a data rate instruction unit 306. If the data rate detection unit 304 determines that it is possible and desirable to slow the communications to/from a first user, to thereby speed up the communications to/from a second user, the data rate instruction unit 306 uses the information developed by the data rate detection unit 304 to cause that change to occur. In some instances, the data rate instruction unit 306 may instruct elements of the IP telephony system 120 to slow the rate at which data is being sent to a user's IP telephony device. In other instances, the data rate instruction unit 306 may instruct a user's IP telephony device to slow the rate at which it is transmitting data to the IP telephony system 120. In still other instances, both of those instructions would be issued. These instructions could include a specific instruction as to how much to slow the data communications, or a generalized instruction to slow the data communications.

Another potential way of deliberately slowing the rate at which data is transferred to a user's IP telephony device would be to deliberately delay the sending of acknowledgement messages to the user's IP telephony device. Under this scheme, the data rate instruction unit 306 sends one or more communications to one or more elements of the IP telephony system that are in contact with the user's IP telephony device. Those elements are instructed to delay the transmission of acknowledgement messages to the user's IP telephony device. Care must be taken to ensure that an acknowledgement message is sent before a timer runs out and the user's IP telephony device assumes that a message has been lost. However, if acknowledgement messages are sent more slowly than is otherwise possible, this would also serve to reduce the rate at which a user's IP telephony device communicates through a data network interface device.

If the data rate instruction unit 306 is instructing a user's IP telephony device to slow its transmission of data to the IP telephony system 120, the instructions could be issued to a software client that is running on the user's IP telephony device. The software client could be directly responsible for slowing the rate of data communications, or the software client might instruct other elements or software clients present on the user's IP telephony device to implement a reduction in the speed of data communications.

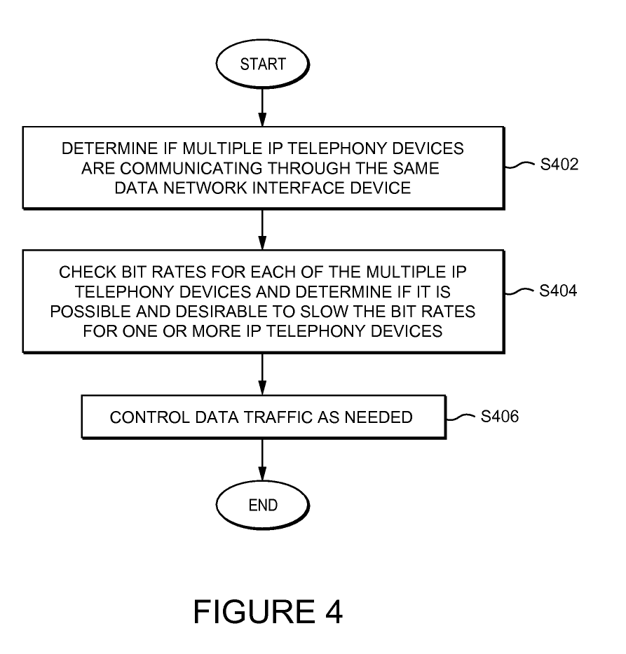

FIG. 4 illustrates steps of a method that would be performed by the data control unit 300 to control the bit rate of communications of one or more users who are communicating with the IP telephony system 120 through the same data network interface device. The method begins and proceeds to step S402 where the IP telephony device identification unit 302 determines if multiple users are communicating with the IP telephony system 120 via the same data network interface device. If so, in step S404 the data rate detection unit 304 determines if it is desirable and possible to slow the communications of one of the multiple users so that another of the multiple users can experience an increase in communication speed. If such an action is possible and desirable, in step S406 the data rate instruction unit 306 issues instructions to implement the desired changes.

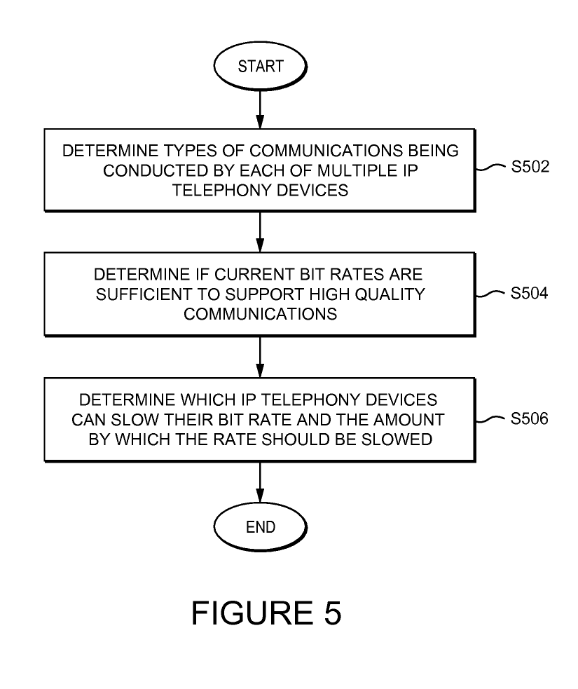

FIG. 5 illustrates steps of a method that would be performed by the data rate detection unit 304 to determine if it is possible and desirable to slow the communications speed of one of multiple users that are communicating through the same data network interface device. This method corresponds to step S404 of the method illustrated in FIG. 4.

The method begins and proceeds to step S502 where the types of communications being conducted by each of the users communicating through the same data network interface device are determined. Next, in step S504, the current speed of the communications being provided to each of the users is determined. The actual communication speed is compared to the speed needed to support quality communications in each case. For example, a user who is conducting an IP telephone call would need a higher bit rate to maintain quality than a user who is simply downloading or uploading files. If the communication speed being provided to one of the users is too low to support high quality for the type of communication they are conducting, the data rate detection unit 304 determines how much additional speed is required to ensure high quality communications. Once this determination is made, in step S506 the data rate detection unit 304 determines if it is possible to slow the communications speed for one or more of the users without impacting the quality of their communications. If so, the data rate detection unit 304 determines how much to slow the communications speed of one or more of the users in order to speed up the communications of the users who require a higher speed so that those uses can obtain high quality communications.

The embodiments illustrated and discussed above are in no way exhaustive and are not intended to be limiting. Any other methods of establishing multiple communications channels to communicate sub-streams of the data packets bearing the media of a telephony communication would also be encompassed by the invention. Likewise, while many of the above-discussed embodiments included two communications channels, alternate embodiments could include more than two communications channels.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing the speed of data passing through a data network interface device, comprising:
determining, with one or more processors, whether multiple Internet Protocol (IP) telephony devices are communicating with an IP telephony system via the same data network interface device; and
controlling, if the determining step indicates that multiple IP telephony devices are communicating via the same data network interface device, the speed at which data is sent to or received from a first one of the multiple IP telephony devices such that a speed of data being sent to or received from a second of the multiple IP telephony devices can be increased.

2. The method of claim 1, wherein during the controlling step, priority is given to the data of any IP telephony devices which are conducting an IP telephone call.

3. The method of claim 1, wherein during the controlling step, data being sent to and received from those IP telephony devices which are conducting an IP telephone call is given higher priority than data being sent to and received from those IP telephony devices that are uploading or downloading a video file.

4. The method of claim 3, wherein during the controlling step, the data being sent to and received from those IP telephony devices which are uploading or downloading a video file is given higher priority than data being sent to and received from those IP telephony devices that are uploading or downloading a non-video file.

5. The method of claim 1, wherein during the controlling step, the data being sent to and received from those IP telephony devices which are uploading or downloading a video file is given higher priority than the data being sent to and received from those IP telephony devices that are uploading or downloading a non-video file.

6. The method of claim 1, wherein the controlling step comprises sending an instruction to the first IP telephony device, the instruction causing the first IP telephony device to reduce a bit rate at which the first IP telephony device sends data through the data network interface device.

7. The method of claim 6, wherein the instruction is sent to an application that is running on the first IP telephony device, and wherein the application acts to reduce a bit rate at which the first IP telephony device sends data through the data network interface device.

8. The method of claim 1, wherein the controlling step comprises causing a reduction in a bit rate at which data is sent to the first IP telephony device via the data network interface device.

9. The method of claim 1, wherein the controlling step comprises delaying the transmission of acknowledgement messages that are sent to the first IP telephony device.

10. The method of claim 1, further comprising determining if the second IP telephony device is unable to communicate data at a sufficiently high bit rate to support quality communications to or from the second IP telephony device, and wherein if the second IP telephony device is unable to communicate data at a sufficiently high bit rate, the controlling step comprises causing the first IP telephony device to reduce the bit rate at which it sends data through the data network interface device.

11. The method of claim 1, further comprising determining if the second IP telephony device is unable to communicate data at a sufficiently high bit rate to support quality communications to or from the second IP telephony device, and wherein if the second IP telephony device is unable to communicate data at a sufficiently high bit rate, the controlling step comprises causing a reduction in a bit rate at which data is sent to the first IP telephony device through the data network interface device.

12. A system for managing the speed of data passing through a data network interface device, comprising:
means for determining whether multiple Internet Protocol (IP) telephony devices are communicating with an IP telephony system via the same data network interface device; and
means for controlling the speed at which data is sent to or received from a first one of the multiple IP telephony devices such that a speed of data being sent to or received from a second of the multiple IP telephony devices can be increased.

13. A system for managing the speed of data passing through a data network interface device, comprising:
a device identification unit that determines whether multiple IP telephony devices are communicating with an IP telephony system via the same data network interface device; and
a data rate instruction unit that acts to control the speed at which data is sent to or received from a first one of the multiple IP telephony devices such that a speed of data being sent to or received from a second of the multiple IP telephony devices can be increased.

14. The system of claim 13, wherein the data rate instruction unit acts to give priority to the data of any IP telephony devices which are conducting an IP telephone call.

15. The system of claim 13, wherein the data rate instruction unit acts to give higher priority to data being sent to and received from those IP telephony devices which are conducting an IP telephone call than data being sent to and received from those IP telephony devices that are uploading or downloading a video file.

16. The system of claim 15, wherein the data rate instruction unit acts to give higher priority to data being sent to and received from those IP telephony devices which are uploading or downloading a video file than data being sent to and received from those IP telephony devices that are uploading or downloading a non-video file.

17. The system of claim 13, wherein the data rate instruction unit acts to give higher priority to data being sent to and received from those IP telephony devices which are uploading or downloading a video file than data being sent to and received from those IP telephony devices that are uploading or downloading a non-video file.

18. The system of claim 13, wherein the data rate instruction unit sends an instruction to the first IP telephony device, the instruction causing the first IP telephony device to reduce a bit rate at which the first IP telephony device sends data through the data network interface device.

19. The system of claim 18, wherein the data rate instruction unit sends the instruction to an application that is running on the first IP telephony device, and wherein the application acts to reduce a bit rate at which the first IP telephony device sends data through the data network interface device.

20. The system of claim 13, wherein the data rate instruction unit acts to cause a reduction in a bit rate at which data is sent to the first IP telephony device via the data network interface device.

21. The system of claim 13, wherein the data rate instruction unit acts to delay the transmission of acknowledgement messages to the first IP telephony device.

22. The system of claim 13, further comprising a data rate detection unit that determines if the second IP telephony device is unable to communicate data at a sufficiently high bit rate to support quality communications to or from the second IP telephony device, and wherein if the second IP telephony device is unable to communicate data at a sufficiently high bit rate, the data rate instruction unit sends an instruction to the first IP telephony device that instructs the first IP telephony device to reduce a bit rate at which the first IP telephony device sends data through the data network interface device.

23. The system of claim 13, further comprising a data rate detection unit that determines if the second IP telephony device is unable to communicate data at a sufficiently high bit rate to support quality communications to or from the second IP telephony device, and wherein if the second IP telephony device is unable to communicate data at a sufficiently high bit rate, the data rate instruction unit acts to reduce a bit rate at which data is sent to the first IP telephony device through the data network interface device.
